(19) United States
(12) Patent Application Publication
(10) Pub. No.: US 2017/0090472 A1
(43) Pub. Date: Mar. 30, 2017

(54) DRIVER ASSISTANCE FOR MATERIAL TRANSFER

(71) Applicants: Michael D. Geerlings, Holland, MI (US); Heidi M. Bostrom, Zeeland, MI (US)

(72) Inventors: Michael D. Geerlings, Holland, MI (US); Heidi M. Bostrom, Zeeland, MI (US)

(21) Appl. No.: 15/282,163

(22) Filed: Sep. 30, 2016

Related U.S. Application Data
(60) Provisional application No. 62/235,035, filed on Sep. 30, 2015.

(51) Int. Cl. G05D 1/00; G05D 1/02; H04W 4/02

(52) U.S. Cl. CPC G05D 1/0027; H04W 4/023; G05D 1/0219; G05D 1/0044; H04W 4/046

(57) ABSTRACT

A system and method of use of said system for communication between a farm implement and a receiving vehicle regarding a position of a chute of the farm implement relative to the farm implement. The system can include a transmitting module provided with the farm implement and a receiving module provided with the receiving vehicle. The transmitting module can include a power source, a position sensing circuit, an encoding circuit, and a transmitter for communicating with the receiving module regarding the position of the chute. The receiving module can include a power source, a user interface, a decoding circuit, and a receiver for receiving signals from the transmitter of the transmitting module indicative of the position of the chute.

### BACKGROUND OF THE INVENTION

Harvesting material from a field typically involves a farm implement that harvests the material and a receiving vehicle traveling alongside the farm implement to receive the material harvested by the farm implement. For example, a farm implement, such as a chopper, can be driven through a field to collect and then expel the collected material, such as grain or chopped corn, to a trailer of a receiving vehicle driven alongside the farm implement. The farm implement can include a chute that is configured to expel the material collected by the farm implement to the trailer of the receiving vehicle traveling alongside the farm implement. The receiving vehicle is generally positioned relative to the farm implement such that the trailer can be filled from front to back.

However, it is difficult for the driver of the receiving vehicle to see the trailer during the harvesting process and determine the fill level of the trailer along a length of the trailer. The chute on the farm implement can have some range of motion to allow for adjustment of the position of the chute, but the range of motion is generally insufficient to allow the receiving vehicle to stay in one place relative to the farm implement during a load cycle because the chute typically moves in an arc. The driver of the receiving vehicle has a very hard time seeing the chute because it is positioned high over the trailer, which is located behind the driver's cab of the receiving vehicle. Because the driver of the receiving vehicle needs to pay attention to where he/she is driving, not much time can be spent looking out the side window to try to determine the position of the chute or to see hand gestures being made by the driver of the farm implement. Further, repeatedly having to use a CB radio to talk to the driver of the farm implement can lead to frustration of both drivers as well as to loss of material due to spillage from a misalignment of the chute relative to the trailer or overfilling of the trailer.

### SUMMARY

The embodiments of the invention relate to a method and system for communicating the relative position of a farm implement and a receiving vehicle.

According to one embodiment, a system for communicating a position of a farm implement includes a transmitting module and a receiving module. The farm implement is collecting material for transfer to a receiving vehicle relative to said farm implement. The farm implement includes a moveable chute for transferring the material collected by the farm implement to the receiving vehicle. The transmitting module includes a position sensing circuit configured to output a signal based on a position of the moveable chute with respect to the farm implement, and encoding circuit, and a transmitter. The encoding circuit is configured to output a signal indicative of the position of the moveable chute based on a signal received from the position sensing circuit regarding the position of the moveable chute. The transmitter is configured to transmit the output signal received from the encoding circuit. The receiving module includes a receiver, a decoding circuit, and a user interface. The receiver is configured to receive the output signal transmitted by the transmitter and the decoding circuit is configured to output a signal indicative of the position of the moveable chute based on the output signal received by the receiver. The user interface is configured to communicate information regarding the relative position of the moveable chute with a driver of the receiving vehicle based on the output signal received from the decoding circuit.

According to another embodiment, the position sensing circuit includes a magnetic sensor, mechanical switches, hall-effect sensors, optical sensors, or combinations thereof. The transmitter is configured to transmit a signal through radio frequency waves, optical signals, or a wired connection.

In another embodiment, the user interface is configured to communicate information using at least one of an optical signal, an audible signal, or combinations therefore. The user interface is optionally configured to communicate information using a plurality of colored lights, text, graphics, or combinations thereof. In one embodiment, the user interface is configured to communicate information using a red, green, and yellow light.

In yet another embodiment, the transmitting module is provided on the farm implement and the receiving module is provided on the receiving vehicle. The additional receiving module can be provided on the farm implement.

In another embodiment, the transmitting module further includes a user interface configured to receive input from a user related to a preferred position or range of positions of the moveable chute.

According to another embodiment of the invention, a method is provided of operating a system for communicating a position of a farm implement that is collecting material for transfer to a receiving vehicle. The farm implement includes a moveable chute for transferring the material collected by the farm implement to the receiving vehicle. The method includes determining a position of the chute relative to the farm implement using at least one position sensor and communicating the position of the chute determined by the at least one position sensor with a receiving module provided on the receiving vehicle. The method further includes displaying, through a user interface of the receiving module, information indicative of the position of the chute received by the receiving module.

In another embodiment, the method further includes adjusting the position of the receiving vehicle relative to the farm implement based on the information displayed on the user interface. In addition, the position of the chute can be communicated with a receiving module provided on the farm implement.

In still another embodiment, the method further includes inputting a desired position of the chute through a user interface provided with the transmitting module. The desired position of the chute can optionally correspond to a range of positions centered about a default position or a range of positions shifted relative to the default position. The determining of a position of the chute optionally further includes determining a position of the chute relative to the desired position of the chute.

In another embodiment, the method includes displaying comprises actuating an indicator when the position of the chute exceeds a position threshold or corresponds to a predetermined range of positions.

### BRIEF DESCRIPTION OF THE DRAWINGS

FIG. 1 is a schematic illustration of a communication system according to an embodiment of the invention;

FIG. 2 is a schematic illustration of a position sensing circuit for use with the communication system of FIG. 1;

FIG. 3 is a schematic illustration of a position sensing circuit and transmitter for use with the communication system of FIG. 1;

FIG. 4 is schematic illustration of a transmitter and receiver for use with the communication system of FIG. 1;

FIG. 5 is schematic illustration of a user interface for use with the communication system of FIG. 1;

FIG. 6 is a flowchart of a process for operating a communication system to communicate a position of a farm implement relative to a receiving vehicle according to an embodiment of the invention;

FIG. 7 illustrates an example of a communication system in operation with a farm implement and vehicle according to an embodiment of the invention;

FIG. 8 illustrates an example of a communication system in operation with a farm implement and vehicle according to an embodiment of the invention;

FIG. 9 illustrates an example of a communication system in operation with a farm implement and vehicle according to an embodiment of the invention;

FIG. 10A illustrates an example of a communication system in operation with a farm implement and vehicle according to an embodiment of the invention;

FIG. 10B illustrates an example of a communication system in operation with a farm implement and vehicle according to an embodiment of the invention.

### DESCRIPTION OF THE CURRENT EMBODIMENTS

### I. Structure

The embodiments of the invention are described in the context of a farm implement which harvests material and has a chute for transferring the harvested material to a trailer of a receiving vehicle. The receiving vehicle and trailer travel adjacent the farm implement for receiving the material expelled from the chute of the farm implement into the trailer. It will be understood that the embodiments of the invention are not limited to a farm implement and harvesting material, but may be utilized with any system in which material is transferred from one location or vehicle to an adjacent traveling vehicle by a chute or other type of conveying apparatus.

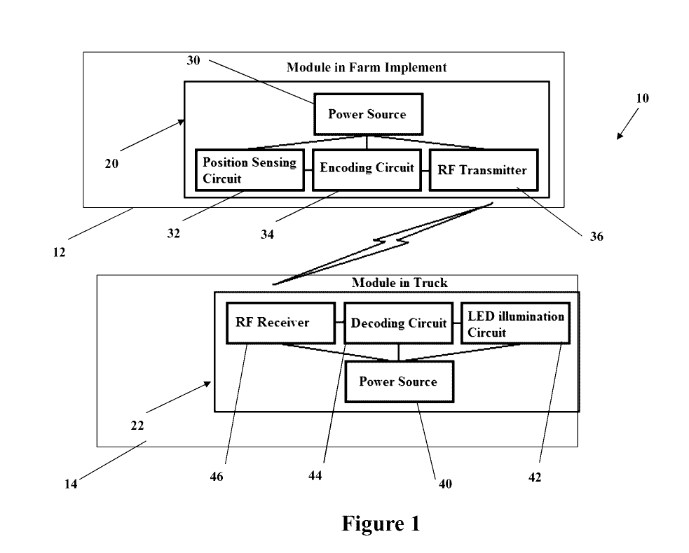

FIG. 1 illustrates a system 10 for communication between a farm implement 12 and a receiving vehicle 14. The communication system 10 can include a transmitting module 20 that is carried by the farm implement 12 and a receiving module 22 that is carried by the receiving vehicle 14. The transmitting module 20 may be integrated into the electronics of the farm implement 12 or a peripheral device that is used in connection with the farm implement 12. Similarly, the receiving module 22 may be integrated into the electronics of the receiving vehicle 14 or a peripheral device that is used in connection with the receiving vehicle 14. Typically, multiple receiving vehicles 14 are used during harvesting and each receiving vehicle 14 can include a receiving module 22 for communication with the transmitting module 20 of one or more farm implements 12.

The transmitting module 20 can include a power source 30, a position sensing circuit 32, an encoding circuit 34, and a transmitter 36 (e.g. a radio frequency RF, or other type of transmitter) for communicating with the receiving module 22. The power source 30 may be an internal power source, such as a battery, or the transmitting module 20 may include connectors for coupling to a power source of the farm implement 12. The receiving module 22 can include a power source 40, a user interface 42, a decoding circuit 44, and a receiver 46 for receiving signals from the transmitter 36 of the transmitting module 20. The transmitter 36 and receiver 46 are configured such that at list one-way, and optionally two-way, communication can occur between the transmitter 36 and the receiver 46. The power source 40 may be an internal power source, such as a battery, or the receiving module 22 may include connectors for coupling to a power source of the receiving vehicle 14. While the communication system 10 is described as communicating via radio frequency, alternative methods of communication, such as optical, wired, wireless methods such as WiFi, Bluetooth, and cellular data, or audible methods can also be used. In environments where dust is present, which is often encountered by farm equipment, RF transmission has an advantage of not being impeded by dust.

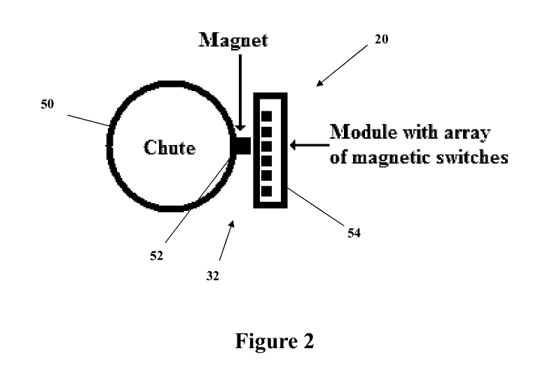

Referring now to FIG. 2, the farm implement 12 can include a moveable chute 50 for transferring material harvested by the farm implement 12 to a suitable trailer of the receiving vehicle 14. The chute 50 can be coupled with the farm implement 12 such that it is moveable relative to the farm implement 12. The position sensing circuit 32 can include at least one position sensor for detecting the position of the chute 50. In the illustrated embodiment, the position sensor is in the form of a magnet 52 positioned on the chute 50 and a sensor module 54, in the form of a magnetic sensor module, configured to detect the position of the magnet 52 for determining the relative position of the chute 50. In the illustrated embodiment, the sensor module 54 can include an array of magnetic switches that are closed based on the position of the magnet 52 relative to the sensor module 54, which is indicative of the position of the chute 50 relative to the farm implement 12. Information regarding the closing and/or opening of the magnetic switches of the sensor module 54 is communicated from the position sensing circuit 32 to the encoding circuit 34 for determining the relative position of the chute 50.

While the embodiments of the invention are described in the context of the position sensing circuit 32 including a magnetic position sensor system, alternative systems for determining the relative position of the chute 50 can also be utilized without deviating from the scope of the invention. Non-limiting examples of sensor systems that can be used to determine the position of the chute 50 include mechanical switches, hall-effect sensors, optical sensors, and other suitable electronic sensors. For example, a light source may be positioned on the chute 50 and the sensor module 54 may be in the form of a light detector array configured to detect light emitted by the light source. In this configuration, the encoding circuit 34 is adapted to determine the relative position of the chute 50 based on the light detected by the sensor module 54. In addition, the farm implement 12 may include multiple position sensors for determining the position of the chute 50.

In another example, the farm implement 12 may include a position sensor system for determining the position of the chute 50 that is independent of the communication system 10. The communication system 10 may be configured to receive information from the farm implement's position sensor system for use in determining the position of the chute 50. Communication between the communication system 10 and the farm implement's position sensor system may occur wirelessly or through a wired connection. In cases in which the chute 50 already includes a position sensor system that communicates the position of the chute 50 with the farm implement 12, the encoding circuit 34 of the transmitting module 20 can be configured to receive and encode the information for communication with the receiving module 22 without the use of the position sensing circuit 32.

In addition to, or as an alternative, the position sensing circuit 32 may be provided on the receiving vehicle 14 such that the position of the chute 50 is determined with respect to the receiving vehicle 14. For example, if it is desired that a distal end of the chute 50 align with a predetermined receiving zone of the receiving vehicle 14, such as a trailer bed, the receiving vehicle 14 may include a position sensor module that detects the distal end of the chute 50. In this configuration, the communication system 10 may be configured to determine the position of the chute 50 relative to the receiving vehicle 14 and communicate this information with either or both of the drivers of the farm implement 12 and/or the receiving vehicle 14. In one example, the receiving vehicle 14 includes both the transmitting module 20 and the receiving module 22. In another example, the receiving vehicle 14 includes both the transmitting module 20 and the receiving module 22 and the farm implement optionally includes a receiving module 22.

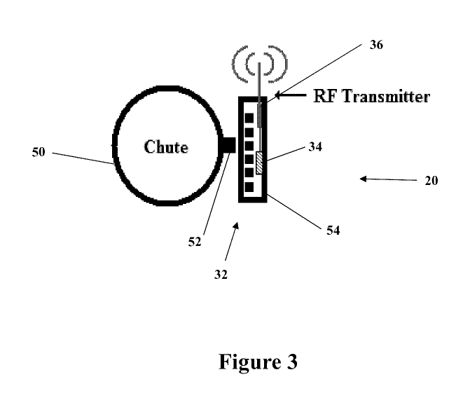

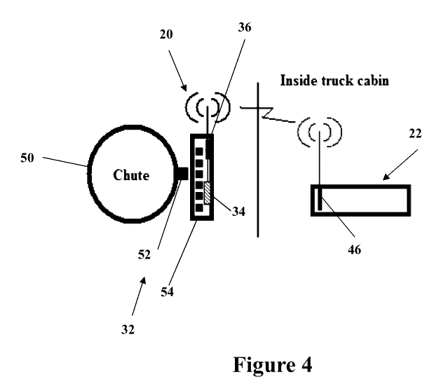

As illustrated in FIGS. 3 and 4, the encoding circuit 34 and the RF transmitter 36 are housed with the sensor module 54. In this example, the transmitting module 20 may be incorporated into the sensor module 54 such that the position sensing circuit 32, encoding circuit 34, RF transmitter 36, and power source 30 are housed within a single device. Alternatively, the transmitting module 20 may be formed from multiple separate devices in communication with one another via a wired or wireless communication. For example, the encoding circuit 34, RF transmitter 36, and power source 30 may be housed in a device separate from the position sensing circuit 32. In this configuration, the sensor module 54 of the position sensing circuit 32 is adapted to communicate sensor information with the encoding circuit 34 for determining the relative position of the chute 50. The sensor module 54 may include a transmitter for wirelessly transmitting the sensor information to the encoding circuit 34, such as through the RF transmitter 36, or may be connected with the encoding circuit 34 by a wired connection.

The sensor module 54 is in communication with the encoding circuit 34 to encode the signal from the sensor module 54 indicative of a relative position of the chute 50 based on the detection of the magnet 52. The sensor module 54 may output a signal to the encoding circuit 34 based on the detection of the magnet 52. The encoding circuit 34 of the transmitting module 20 can be configured to receive the output signal from the magnetic switch array of the sensor module 54 which corresponds to a position of the chute 50 and output a signal indicative of the position of the chute 50. The encoding circuit 34 can encode the output signal for broadcast by the RF transmitter 36 to the RF receiver 46 in the receiving vehicle 14. The encoding circuit 34 may optionally include a control system including a controller and memory. The controller can be configured to receive sensor data from the position sensing circuit and analyze the sensor data according to one or more software programs, algorithms, or databases stored in the memory to determine the relative position of the chute 50. The memory may optionally be configured to store information regarding a user's chute position preferences, as described below.

The sensor module 54 may be configured to output a signal to the encoding circuit 34 continuously or at a predetermined rate. Likewise, the encoding circuit 34 can encode the output signal for broadcast and the RF transmitter 36 can broadcast the output signal continuously or at a predetermined rate. In one example, encoding the output signal by the encoding circuit 34 can include processing the signals received from the sensor model 54, such as averaging or smoothing the signal.

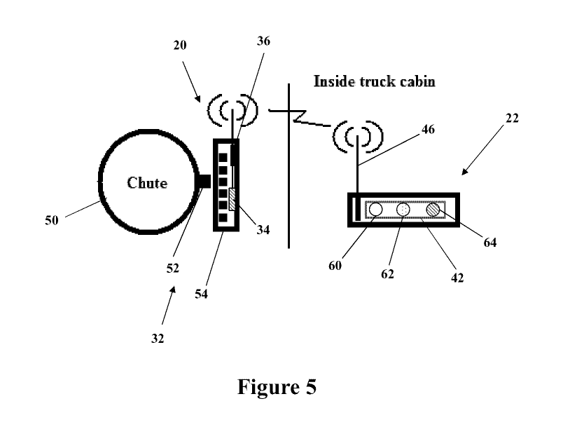

Referring now to FIG. 5, the user interface 42 is configured to communicate information received by the receiving module 22 from the transmitting module 20 with the driver of the receiving vehicle 14. The decoding circuit 44 of the receiving module 22 can be configured to decode the information received by the RF receiver 46 based on the configuration of the user interface 42 to communicate information with the driver of the receiving vehicle 14 regarding the relative position of the chute 50. In the embodiment illustrated in FIG. 5, the user interface 42 includes a plurality of indicators, such as different colored lights: a red LED 60 (shaded gray), a yellow LED 62 (dotted), and a green LED 64 (diagonal lines), to communicate information with the driver of the receiving vehicle 14. The user interface 42 can include any number, shape, and/or color of illuminable indicators to communicate information with the driver. In another example, the user interface 42 can include a display screen configured to display text, graphics, and/or colored illumination based on the information received by the RF receiver 46 from the RF transmitter 36. In another example, the user interface 42 can include illuminable icons that are illuminated based on the information to be conveyed to the driver.

Alternatively, or in addition to communicating with the driver optically, the user interface 42 can be configured to communicate with the driver of the receiving vehicle 14 using audible sounds. For example, the tempo or tone of a series of audible sounds can increase or decrease based on the information to be communicated to the driver of the receiving vehicle 14.

While the encoding circuit 34 is described in the context of the transmitting module 20, it is also within the scope of the invention for the encoding circuit 34 to be housed with the receiving module 22 on the receiving vehicle 14. In this configuration, the sensor module 54 is adapted to provide an output signal based on detection of the magnet 52 to the RF transmitter 36 for communication with the RF receiver 46. The RF receiver 46 communicates the output signal with the encoding circuit 34, which is configured to determine a position of the chute 50 based on the output signal and generate an output signal indicative of the position of the chute 50. The output signal indicative of the position of the chute 50 is then provided to the decoding circuit 44. In another example, rather than having a separate encoding circuit 34 and decoding circuit 44, these circuits may be combined into a single component.

In another embodiment, the farm implement 12 may also include a user interface for communicating the same information communicated to the driver of the receiving vehicle 14 with the driver of the farm implement 12. For example, the farm implement 12 may also include a receiving module 22 which receives the signal broadcast by the RF transmitter 36. In this manner, the driver of the farm implement 12 may be kept aware of the information being displayed to the driver of the receiving vehicle 14.

In another embodiment, the communication system 10 may be configured for use with a smart device, such as a smart phone, a tablet, or a laptop computer. The receiving module 22 may be incorporated into a software application that can be run as a local application on the smart device or as a remote application through a web browser that is configured to decode the output signal received from the transmitting module 20 and display information regarding the position of the chute 50 to the user. In one example, the position sensing circuit 32 communicates the sensor output signal with an encoding circuit 34 which is incorporated into a software application that is running on a connected smart device. Alternatively, the encoding circuit 34 may be housed with the position sensing circuit 32 and the encoding circuit 34 may be configured to output a signal indicative of the position of the chute 50 to a connected smart device. The smart device may be connected with the position sensing circuit 32 and/or the encoding circuit 34 using a wired connection, such as USB, or a wireless connection, such as Wi-Fi or Bluetooth.

The decoding circuit 44 may be programmed into the software application such that the application can decode the output signal received from the position sensing circuit 32 and/or the encoding circuit 34 and generate a signal that the software application uses to communicate the position of the chute 50 through the user interface 42 of the smart device. The decoding circuit programming may be installed in a software application being run on the smart device in the farm implement 12 and/or the receiving vehicle 14. The software application can be configured to display colors, text, and/or graphics on the user interface 42 of the smart device to communicate the position of the chute 50 according to any of the methods described herein. For example, the software application can be configured to cause the user interface 42 to be illuminated in green, red, or yellow light, based on the position of the chute 50. Optionally, the software application can be configured to cause the smart device to emit a sound based on the position of the chute 50.

When the communication system 10 is configured for use with smart devices, the smart device in the farm implement 12 may be configured to run a software application configured to perform only the functions of the encoding circuit 34 or the functions of the encoding circuit 34, the decoding circuit 44, and/or the user interface 42. The smart device in the receiving vehicle 14 may include the same software application as the device in the farm implement 12 or a software application that is configured to only perform the functions of the receiving module 22. The software application can be configured such that the smart device can perform all of the encoding, decoding, transmitting, and displaying functions of the transmitting and receiving modules 12 and 14 on each smart device. Alternatively, the software application can be configured to perform only those functions corresponding to the vehicle in which the smart device is located. For example, the smart device in the farm implement 12 can utilize a software application that performs only the functions of the transmitting module 12 while the smart device in the receiving vehicle 14 can utilize a software application that is configured to perform only the functions of the receiving module 14.

In one exemplary embodiment, the smart device in the farm implement 12 is running a software application that allows the smart device to receive the output signal from the position sensing circuit 32 and encode the output signal (encoding circuit 34) for transmitting to a smart device in the receiving vehicle 14. The smart device in the farm implement 12 may be connected with the position sensing circuit 32 via a wired connection, such as a USB, or a wireless connection, such as Wi-Fi or Bluetooth. In this example, the transmitter 36 of the smart device may transmit the encoded output signal to the smart device in the receiving vehicle 14 via cellular data, a Wi-Fi, or Bluetooth connection to the communications receiver 46 in the smart device in the receiving vehicle 14. The smart device in the receiving vehicle 14 may be running a software application that includes the decoding circuit 44 for decoding the output signal and generating a signal that causes the user interface 42 to display information regarding the position of the chute 50. Optionally, the signal generated by the decoding circuit 44 may be communicated with the control system of an autonomous receiving vehicle 14 which is configured to adjust the speed of the receiving vehicle 14 automatically, based on the signal indicative of the position of the chute 50.

### II. Operation

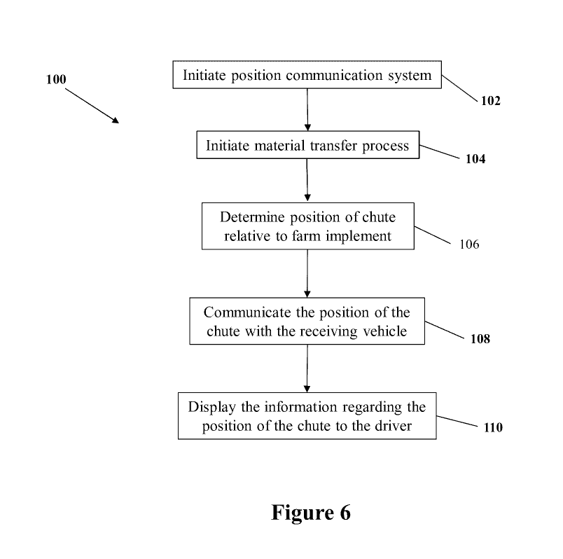

FIG. 6 illustrates a method 100 of communicating information regarding the position of the chute 50 with the driver of the receiving vehicle 14. The method 100 begins at 102 with initiation of the position communication system 10, including the transmitting module 20 and the receiving module 22 automatically and/or manually. The initiation of the position communication system 10 may occur automatically upon ignition of the engine of the corresponding farm implement 12 and receiving vehicle 14. Additionally, or alternatively, the transmitting module 20 and the receiving module 22 may be manually turned on by the drivers of the respective farm implement 12 and receiving vehicle 14.

At 104, the material transfer process is initiated. In the case of harvesting a material on a farm, the material transfer process at 104 may include activation of the farm implement 12 to harvest the material. In another example, at least a portion of the material to be harvested has already been harvested and is carried by the farm implement 12 and initiation of the material transfer process at 104 includes activation of the chute 50 to transfer the harvested material to the receiving vehicle 14. It is also within the scope of the invention for the material transfer process 104 to be initiated prior to or concomitantly with initiation of the communication system 10 at 102.

Prior to, subsequent to, or concomitantly with the initiation of the material transfer process at 104, the position of the chute 50 relative to the farm implement 12 is determined at 106. The position of the chute 50 is determined by the transmitting module 20 using the position sensing circuit 32 described above. The position of the chute 50 may be continuously determined or periodically determined at a predetermined rate and may be adjustable of fixed. In one example, the rate of determining the position of the chute 50 may be based on an estimated or measured rate of travel of the farm implement 12 during harvesting. In another example, the rate of determining the position of the chute 50 may be adjusted by the driver of the farm implement 12.

At 108, the position of the chute is communicated with the receiving vehicle 108. This may include the encoding circuit 34 receiving information from the position sensing circuit 32 based on the detected position of the chute 50 and outputting a signal indicative of the position of the chute 50 to the RF transmitter 36. Alternatively, the encoding circuit 34 may be provided in the receiving module 22 such that the RF transmitter 36 outputs the position sensor signal from the position sensing circuit 32 to the receiving module 22 for encoding and subsequent decoding. The RF receiver 46 receives the output signal indicative of the position of the chute 50 from the RF transmitter 36 and communicates the signal with the decoding circuit 44.

At 110, the decoding circuit 44 determines the position of the chute 50 based on the output signal received from the encoding circuit 34 through the RF transmitter and receiver 36 and 46 and generates an output signal that actuates a user interface to display the determined chute position with the driver of the receiving vehicle 14. The output signal generated by the decoding circuit 44 may be generated continuously or occur at a predetermined rate. In one example, the decoding circuit 44 may be configured to generate a signal that actuates the user interface only when there is a change in the position of the chute 50 to be indicated to the driver of the receiving vehicle 14. The user interface may communicate the information regarding the position of the chute 50 with the driver according to any of the visual and/or audible methods described herein.

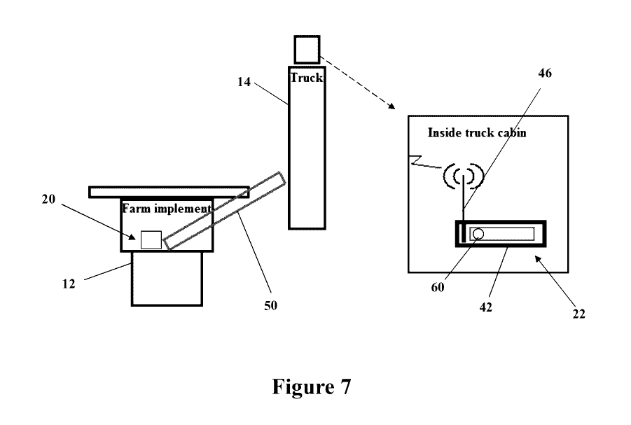

FIGS. 7-9 illustrate one embodiment of operation of the communication system 10 according to the method 100 to communicate information with the driver of the receiving truck 14 to facilitate positioning the receiving truck 14 relative to the chute 50 of the farm implement 12 for receiving material transferred therefrom. In the embodiments illustrated in FIGS. 7-9, the user interface 42 in the receiving vehicle 14 includes a green, red, and yellow LED light 60, 62, and 64, respectively, which are illuminated depending on the information received by the receiving module 22 from the transmitting module 20 of the farm implement 12.

Referring now to FIG. 7, a scenario is illustrated in which the chute 50 is rotated forward (i.e. in the direction the farm implement 12 is traveling) and the receiving vehicle 14 has pulled ahead of the farm implement 12. The chute 50 may be considered to be rotated forward when the chute 50 exceeds a threshold, such as an angle relative to a default or centered position, or when the chute 50 is determined to be within a predetermined range of positions outside a default or centered position or range of positions. In this scenario, the magnetic switch in the sensor module 54 indicative of the chute 50 being rotated forward relative to the farm implement 12 senses the magnet 52 and closes. The encoding circuit 34 encodes the signal from the sensor module 54 for transmission by the RF transmitter 36 to the RF receiver 46 in the receiving vehicle 14. The decoding circuit 44 is configured to receive the signal from the RF receiver 46 indicative of the chute 50 being rotated forward and send a signal to the user interface 42 to illuminate the red LED 60 (gray). Illumination of the red LED 60 (gray) indicates to the driver of the receiving vehicle 14 that the receiving vehicle 14 is too far ahead of the farm implement 12 and should drop back, for example, stop or slow down.

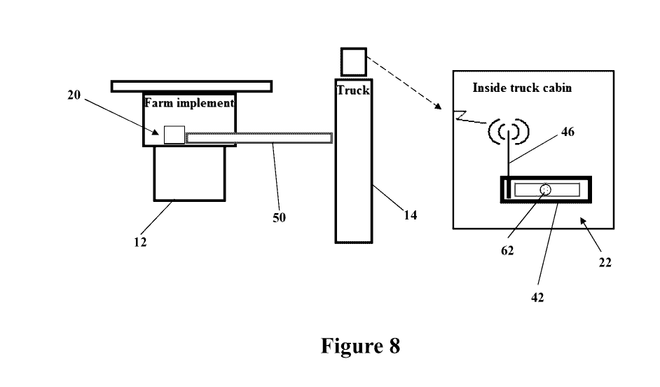

Similarly, with reference to FIG. 8, when the receiving vehicle 14 is traveling adjacent the farm implement 12 with the chute 50 in a centered position, the magnet 52 on the chute 50 is detected by the sensor module 54 and the magnetic switch in the sensor module 54 indicative of the chute 50 being in the centered position senses the magnet 52 and closes. The centered position may correspond to a default position or range of positions or to desired position or range of positions. The encoding circuit 34 receives the signal from the closing of the magnetic switch and communicates this information with the receiving module 22 through the RF transmitter 36 and the RF receiver 46. The decoding circuit 44 receives the signal from the RF receiver 46, determines the relative position of the chute 50 based on the output signal, and transmits a signal to the user interface 42 to illuminate the yellow LED 62 (dotted). Illumination of the yellow LED 62 (dotted) indicates to the driver of the receiving vehicle 14 that the receiving vehicle 14 is in a good position relative to the farm implement 12.

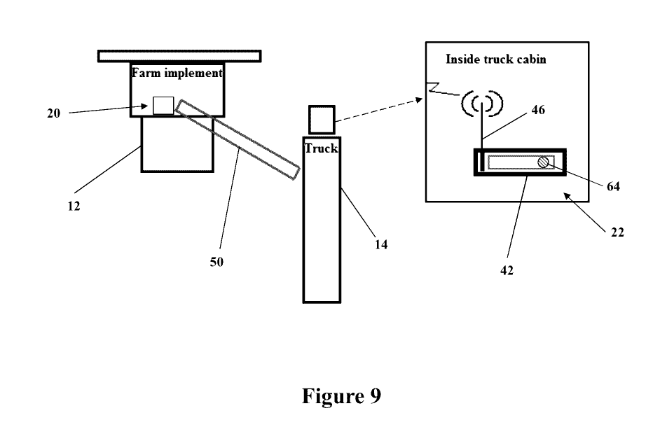

Referring now to FIG. 9, a scenario is illustrated in which the chute 50 is rotated rearward (i.e. in a direction opposite to the direction the farm implement 12 is traveling) and the receiving vehicle 14 has fallen behind the farm implement 12. The chute 50 may be considered to be rotated rearward when the chute 50 exceeds a threshold, such as an angle relative to a default or centered position, or when the chute 50 is determined to be within a predetermined range of positions outside a default or centered position or range of positions. In this scenario, the magnetic switch in the sensor module 54 indicative of the chute 50 being rotated rearward closes. The encoding circuit 34 receives the signal generated by the closed magnetic switch and encodes the signal from the sensor module 54 for transmission by the RF transmitter 36 to the RF receiver 46 in the receiving vehicle 14. The decoding circuit 44 is configured to receive the signal from the RF receiver 46 indicative of the chute 50 being rotated rearward and send a signal to the user interface 42 to illuminate the green LED 64 (diagonal lines). Illumination of the green LED 64 (diagonal lines) indicates to the driver of the receiving vehicle 14 that the receiving vehicle 14 is too far behind the farm implement 12 and should advance relative to the farm implement 12.

In each of the scenarios illustrated in FIGS. 7-9, in addition to communicating information to the driver of the receiving vehicle to increase or decrease speed, the information may also be communicated with the driver of the farm implement 12. For example, illumination of the green LED 64 may indicate to the driver of the receiving vehicle 14 to communicate to the driver of the farm implement 12 a request to decrease the speed of the farm implement 12 through a communication channel. Non-limiting examples of a communication channel may include radio communication, cell phone, signal lights, and/or a signal flag. In another example, the farm implement 12 may also include a receiving module 22 such that the information regarding the position of the chute 50 displayed to the driver of the receiving vehicle 14 is also displayed to the driver of the farm implement 12. This may help the driver of the farm implement 12 be aware of the current position of the receiving vehicle 14 and its likely next course of action. The driver of the farm implement 12 may also use the information to adjust the movement of the farm implement 12.

The communication system 10 can also be configured based on an individual driver's preference for the position of the chute 50. For example, the transmitting module 20 can include a user interface configured to allow a driver of the farm implement 12 to input information regarding the preferred position of the chute 50. In this configuration, the encoding circuit 34 may be programmed to determine whether or not the chute 50 is in the desired position or range of positions and generate a signal indicative of the position of the chute 50 for broadcast by the RF transmitter 36. The decoding circuit 44 is programmed to generate a signal to actuate the appropriate indicator on the user interface 42 based on the position of the chute 50 relative to the desired position (or range of positions).

In one embodiment, the user interface of the transmitting module 20 may be configured to allow a user to provide input regarding a range of motion relative to a default centered position corresponding to a desired chute position. For example, a user may set the preferred chute position as a range of plus-or-minus 10 degrees about the default centered position or a predetermined range of angles shifted 10 degrees ahead or behind the default position. In another example, the user may calibrate the desired chute position by placing the chute 50 in each of the limits of the desired range of chute positions and indicating each limit by selecting an appropriate input mechanism, such as a button or switch.

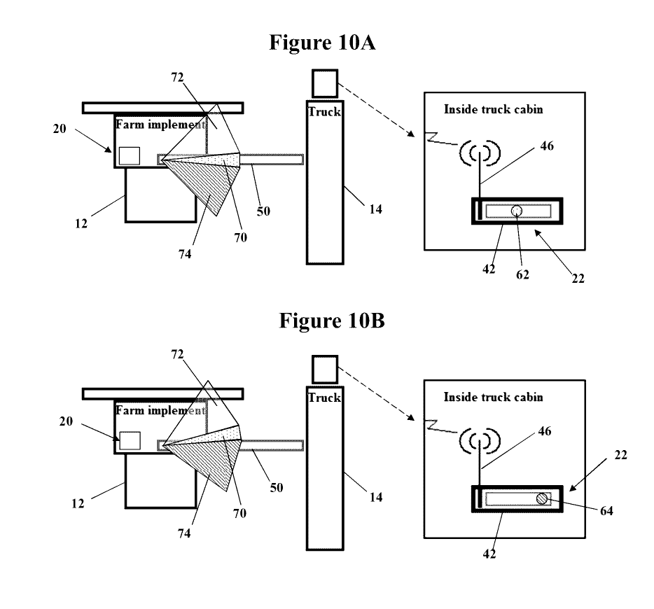

FIG. 10A illustrates a scenario in which a preferred or a default setting for position of the chute 50 is in the centered position. When the chute 50 is in the centered position, illustrated by dotted wedge 70, the yellow LED 62 (dotted) is illuminated. When the chute 50 moves into the red zone, illustrated by the gray wedge 72, the red LED 60 is illuminated, indicating to the driver of the receiving vehicle 14 that the receiving vehicle 14 is too far ahead of the farm implement 12. When the chute 50 is within the green zone, illustrated by the diagonal line wedge 74, the green LED 64 is illuminated, indicating that the receiving vehicle 14 is too far behind the farm implement 12, as described above.

Alternatively, with reference to FIG. 10B, the chute position zones 70, 72, and 74 corresponding to each LED 60, 62, and 64, respectively, can be shifted based on the preference of the driver of the farm implement 12. For example, if a driver of the farm implement 12 prefers to have the chute 50 rotated 5 degrees forward, the transmitting module 20 and receiving module 22 can be configured such that the illumination of the LEDs in the user interface 42 are adjusted to account for the driver's preference. In this case, the communication system 10 would be configured such that the red LED 60 is illuminated when the chute 50 is in the forward plus 5 degrees position (grey zone 72), the yellow LED 62 is illuminated in the centered plus 5 degrees position (dotted zone 70), and the green LED 64 (diagonal lines) is illuminated when the chute 50 is in the rearward plus 5 degree position (diagonal line zone 74, shown in FIG. 10B). As illustrated in FIG. 10B, because the farm implement driver's preference is forward plus 5 degrees, when the chute 50 is in the centered position, the chute 50 is within the diagonal lines zone 74 and the green LED 64 (diagonal lines) is illuminated to indicate to the driver of the receiving vehicle 14 that the vehicle 14 should be advanced relative to the farm implement 12 to move the chute 50 into the preferred centered plus 5 degrees position (dotted zone 70).

In an alternative embodiment, the communication system 10 may be used with a receiving vehicle 14 that is configured as an autonomous or driverless vehicle that is capable of navigating without human input. In this embodiment, alternative to, or in addition to, displaying the relative position information on the user interface 42, the decoding circuit 44 can communicate the relative position information directly with the driverless vehicle's control system such that the driverless vehicle will adjust its navigation based on the information received from the decoding circuit 44 regarding the position of the chute 50. In this embodiment, the communication system 10 and the receiving vehicle 14 would operate in manner similar to what is described above with respect to FIGS. 1-10, except that the receiving vehicle 14 would automatically adjust its travel rather than rely on a driver to manually adjust the vehicle's travel. In this configuration, the receiving module 22 optionally does not include the user interface 42.

The embodiments of the invention described herein allow a desired or optimal position of the receiving vehicle to be automatically communicated with the driver of the receiving truck based on the positioning of the chute by the driver of the farm implement. For example, if the driver of the farm implement is “reaching” because the receiving vehicle is too far forward, the driver of the receiving vehicle will automatically know to drop back because the driver of the receiving vehicle will know that the chute is reaching forward. Similarly, if the driver of the farm implement is “reaching” because the receiving vehicle is too far behind, the driver of the receiving vehicle will automatically know to pull forward because the driver of the receiving vehicle will know that the chute is reaching rearward. The methods and systems described herein provide automatic communication between the driver of the farm implement and the driver of the receiving truck in a manner that can be less distracting and confusing than relying on hand signals or verbal communication between drivers.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A system for communicating a position of a farm implement that is collecting material for transfer to a receiving vehicle relative to said farm implement, the farm implement having a moveable chute for transferring the material collected by the farm implement to the receiving vehicle, the system comprising:
a transmitting module comprising:
a position sensing circuit configured to output a signal based on a position of the moveable chute with respect to the farm implement;
an encoding circuit configured to output a signal indicative of the position of the moveable chute based on a signal received from the position sensing circuit regarding the position of the moveable chute; and
a transmitter configured to transmit the output signal received from the encoding circuit; and
a receiving module comprising:
a receiver configured to receive the output signal transmitted by the transmitter;
a decoding circuit configured to output a signal indicative of the position of the moveable chute based on the output signal received by the receiver; and
a user interface configured to communicate information regarding the relative position of the moveable chute with a driver of the receiving vehicle based on the output signal received from the decoding circuit.

2. The system of claim 1 wherein the position sensing circuit comprises a magnetic sensor, mechanical switches, hall-effect sensors, optical sensors, or combinations thereof.

3. The system of claim 1 wherein the transmitter is configured to transmit a signal through radio frequency waves, optical signals, or a wired connection.

4. The system of claim 1 wherein the user interface is configured to communicate information using at least one of an optical signal, an audible signal, or combinations therefore.

5. The system of claim 4 wherein the user interface is configured to communicate information using a plurality of colored lights, text, graphics, or combinations thereof.

6. The system of claim 1 wherein the user interface is configured to communicate information using a red, green, and yellow light.

7. The system of claim 1 wherein the transmitting module is provided on the farm implement and the receiving module is provided on the receiving vehicle.

8. The system of claim 7 wherein an additional receiving module is provided on the farm implement.

9. The system of claim 1 wherein the transmitting module further includes a user interface configured to receive input from a user related to a preferred position or range of positions of the moveable chute.

10. A method of operating a system for communicating a position of a farm implement that is collecting material for transfer to a receiving vehicle relative to said farm implement, the farm implement having a moveable chute for transferring the material collected by the farm implement to the receiving vehicle, the method comprising:
determining a position of the chute relative to the farm implement using at least one position sensor;
communicating the position of the chute determined by the at least one position sensor with a receiving module provided on the receiving vehicle; and
displaying, through a user interface of the receiving module, information indicative of the position of the chute received by the receiving module.

11. The method of claim 10, further comprising adjusting the position of the receiving vehicle relative to the farm implement based on the information displayed on the user interface.

12. The method of claim 10 wherein the at least one position sensor comprises a magnetic sensor, mechanical switches, hall-effect sensors, optical sensors, or combinations thereof.

13. The method of claim 10 wherein the communicating comprises transmitting a signal through radio frequency waves, optical signals, or a wired connection.

14. The method of claim 10 wherein the displaying comprises at least one of an optical signal, an audible signal, or combinations therefore.

15. The method of claim 14 wherein the user interface is configured to communicate information using a plurality of colored lights, text, graphics, or combinations thereof.

16. The method of claim 10, further comprising communicating the position of the chute with a receiving module provided on the farm implement.

17. The method of claim 10, further comprising inputting a desired position of the chute through a user interface provided with the transmitting module.

18. The method of claim 17 wherein the desired position of the chute corresponds to a range of positions centered about a default position or a range of positions shifted relative to the default position.

19. The method of claim 17 wherein the determining a position of the chute further comprises determining a position of the chute relative to the desired position of the chute.

20. The method of claim 10 wherein the displaying comprises actuating an indicator when the position of the chute exceeds a position threshold or corresponds to a predetermined range of positions.
